(19) United States
(12) Patent Application Publication
(10) Pub. No.: US 2007/0146327 A1
(43) Pub. Date: Jun. 28, 2007

(54) Optical mouse and an optical structure of the optical mouse

(76) Inventor: Yuan-Jung Chang, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/316,750

(22) Filed: Dec. 27, 2005

(51) Int. Cl. G09G 5/08

(52) U.S. Cl. 345/166

(57) ABSTRACT

An optical mouse and an optical structure of the optical mouse, wherein the optical mouse comprises a casing, an optical structure and a circuit board. The optical structure is mounted inside the casing. The optical structure includes a lens set, an LED luminous element, a laser luminous element and an image-detecting element. The laser luminous element and the LED luminous element are mounted on the lens set and are opposite to each other or perpendicular and adjacent to each other and have an included angle with the horizontal plane. The circuit board is disposed inside the casing and is electrically connected to the LED luminous element, the laser luminous element, and the image-detecting element respectively for driving the optical structure; whereby the optical mouse is suitable for operating on any kind of surface.

### BACKGROUND OF THE INVENTION

1. Field of the Invention

The present invention relates to an optical mouse and an optical structure of the optical mouse, and, more particularly, the optical structure provides a coherent light source and an incoherent light source, so that the optical mouse can work on any kind of surface.

2. Description of the Related Art

Optical mice, operate on a main principle using a luminous element, such as a light emitting diode (LED), and emit incident light to a table surface or a mouse pad. By receiving the reflected light produced by the applied plane optical mice determine the uneven surface of the applied plane and track the movement of the optical mouse, such as can be seen in TW. Pat. No. 093205855.

Referring to FIG. 1, which is a cross-sectional view of an optical structure of an optical mouse. The optical structure 1a is mounted inside a casing 2a of the optical mouse. The optical structure 1a has a lens set 3a, an LED luminous element 4a and an image-detecting element 5a. The lens set 3a is disposed on the bottom portion of the casing 2a. The lens set 3a has a first lens 31a and a second lens 32a. The LED luminous element 4a is disposed opposite to the first lens 31a. The image-detecting element 5a is disposed opposite to the second lens 32a. The light signal emitted from the LED luminous element 4a passes through the first lens 31a and is refracted by the first lens 31a to a reflecting plane 6a, such as a table surface. After that, the light signal is refracted to the second lens 32a, and then passes to a receiving portion of the image-detecting element 5a.

However, the light signal emitted from the LED luminous element 4a has to pass through the first lens 31a, the reflecting plane 6a and the second lens 32a to the image-detecting element 5a, so that the light signal will weaken in the process. In other words, the light signal cannot be completely sent to the image-detecting element 5a. When the light signal is weakened, the sensitivity and the accuracy of the image-detecting element 5a will be reduced and this will influence the performance of the optical mouse.

Furthermore, when the optical mouse is used on a smooth surface, the optical mouse doesn't work as well as it can. Therefore, the optic image analysis cannot provide accurate data to the computer to move the optical mouse precisely.

### SUMMARY OF THE INVENTION

It is therefore a principal object of the present invention to provide an optical structure of an optical mouse that adds a laser luminous element for increasing the detecting performance of the optical mouse and enhances the sensitivity of the optical mouse.

It is therefore a secondary object of the present invention to provide an optical mouse, which can work on any kind of surface. The present invention has been accomplished to eliminate the aforesaid problem.

To achieve the above objects, one feature of the present invention is provided for an optical mouse and an optical structure of the optical mouse, wherein the optical mouse includes a casing, an optical structure and a circuit board. The optical structure is mounted inside the casing, and includes a lens set, an LED luminous element, a laser luminous element and an image-detecting element. The lens set is mounted on a bottom portion of the casing. The LED luminous element is mounted on a side of the lens set and has an included angle with a horizontal plane. The laser luminous element is mounted on another side of the lens set and is opposite to or perpendicular and adjacent to the LED luminous element and has an included angle with the horizontal plane. The image-detecting element is disposed on a top portion of the lens set for receiving an image produced by the LED luminous element and the laser luminous element projecting a light beam to any kind of surface. The circuit board is disposed inside the casing and is electrically connected to the LED luminous element, the laser luminous element, and the image-detecting element respectively for driving the optical structure, whereby the optical mouse is suitable for operating upon any kind of surface.

To provide a further understanding of the invention, the following detail description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a cross-sectional view of a conventional optical structure of an optical mouse.

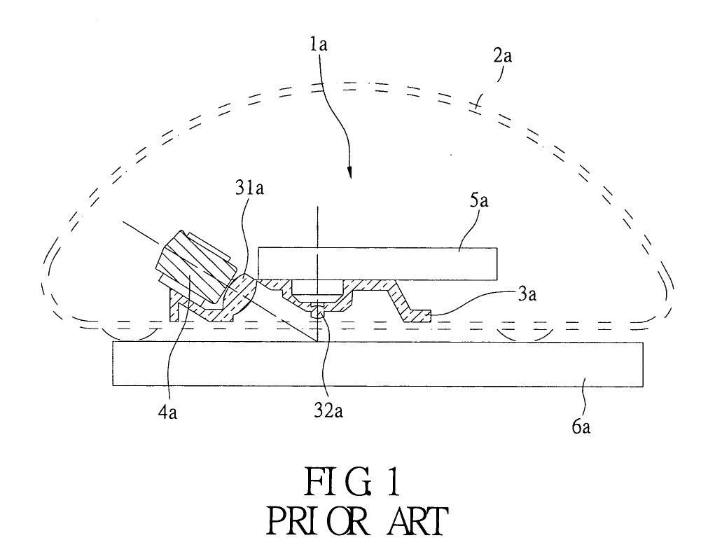

FIG. 2 is a decomposition view of first preferred embodiment of the optical structure of the optical mouse of the present invention.

FIG. 3 is a composition view of first preferred embodiment of the optical structure of the optical mouse of the present invention.

FIG. 4 is a cross-sectional view of first preferred embodiment of the optical structure of the optical mouse of the present invention.

FIG. 5 is a partial composition view of the preferred embodiment of the optical mouse of the present invention.

FIG. 6 is a decomposition view of second preferred embodiment of the optical structure of the optical mouse of the present invention.

FIG. 7 is a composition view of second preferred embodiment of the optical structure of the optical mouse of the present invention.

### DETAILED DESCRIPTION OF THE EMBODIMENTS

Referring now to the drawings wherein the showings are for purposes of illustrating preferred embodiments of the present invention only, and not for purposes of limiting the same.

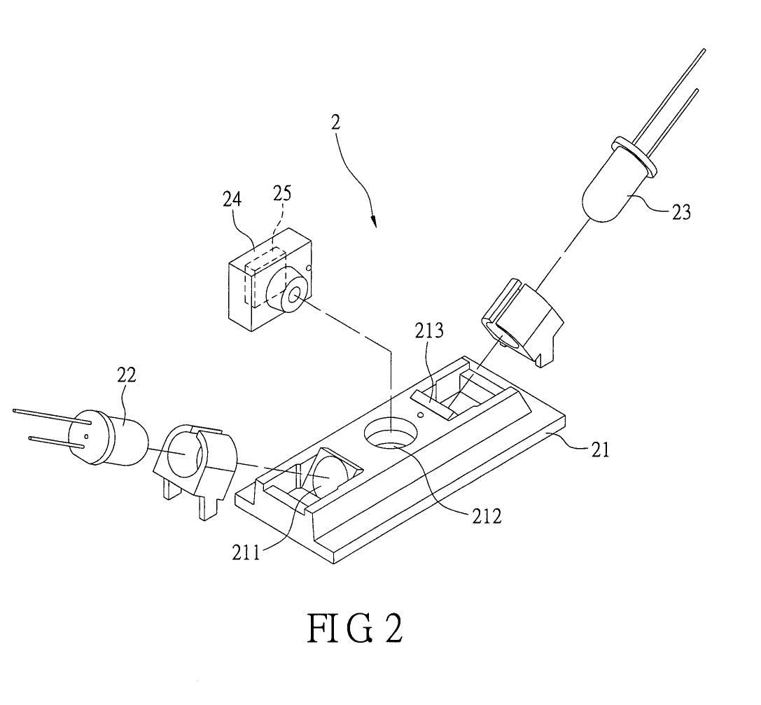

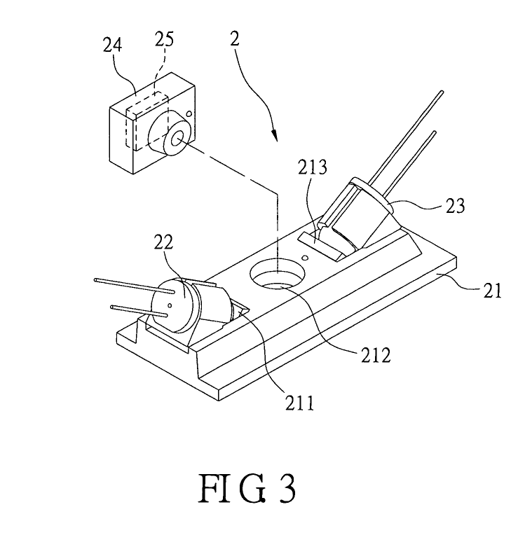

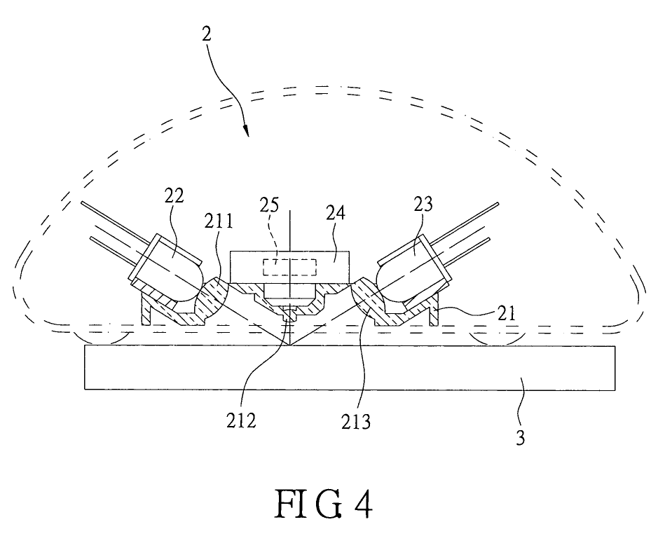

Referring to FIGS. 2 to 4. The present invention provides an optical structure 2 for an optical mouse, which is mounted inside a casing of the optical mouse, and includes a lens set 21, an LED luminous element 22, a laser luminous element 23, an image-detecting element 24 and a digital signal processing element 25.

The lens set 21 is mounted on a bottom portion of the casing. The lens set 21 has a first lens 211, a second lens 212 and a third lens 213. The first lens 211, the second lens 212 and the third lens 213 are integrally formed on the lens set 21.

The LED luminous element 22 is mounted on a side of the lens set 21 and has an included angle with a horizontal plane. The LED luminous element 22 is opposite to the first lens 211, so that the LED luminous element 22 will emit with a predetermined incident angle. An optical designer designed the predetermined incident angle. The optical designer can choose an angle, which enhances the transferring performance of any kind of surface, to increase the transferred degree of the incident light, so that the sensitivity of the optical mouse will be enhanced. The incident light will be refracted by the first lens 211 and focus on the surface 3 over which the optical mouse slid.

The laser luminous element 23 is mounted on another side of the lens set 21, is opposite to the LED luminous element 22 and has an included angle with the horizontal plane. The laser luminous element 23 is opposite to the third lens 213, so that it will emit with a predetermined incident angle. The incident light will be refracted by the third lens 213 and focus on the surface 3 on which the optical mouse slid. The optical structure 2 of the optical mouse having the laser luminous element 23 as the light source will enhance the sensitivity of the optical mouse to the surface of an object. Hence, if the optical mouse moves on the smooth surface, it still can transmit the data of the displacement precisely to the computer.

The image-detecting element 24 is broadly disposed on a top portion of the lens set 21 horizontally for receiving an image produced by the LED luminous element 22 and the laser luminous element 23 projecting a light beam to any kind of surface 3. The image-detecting element 24 is opposite to the second lens 212. Therefore, after the incident light is emitted from the LED luminous element 22 and the laser luminous element 23 is transferred to any kind of surface 3, it will be reflected to the image-detecting element 24.

The digital signal processing element 25 is electrically connected inside the image-detecting element 24 for receiving an image data token via the image-detecting element 24 and computing the moving direction and a distance to the optical mouse precisely. Therefore, the optical structure 2 can exactly and sensitively detect the image produced by the optical mouse sliding over any kind of surface 3.

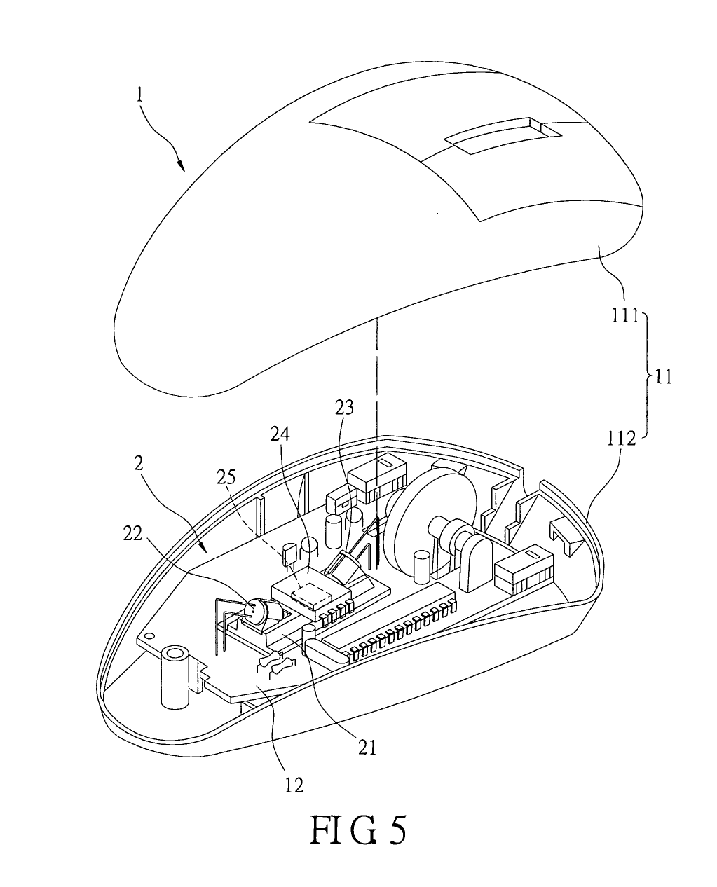

FIG. 5 shows a partial composition view of the preferred embodiment of the optical mouse of the present invention. The present invention provides an optical mouse 1, including a casing 11, an optical structure 2 and a circuit board 12.

The casing 11 includes a top cover 111 and a bottom casing 112. The top cover 111 is mounted to the bottom casing 112. The casing 11 defines an interior space between the top cover 111 and the bottom casing 112 for accommodating the optical structure 2 and the circuit board 12.

The optical structure 2 is mounted inside the casing 11, and includes a lens set 21, an LED luminous element 22, a laser luminous element 23, an image-detecting element 24 and a digital signal processing element 25. The lens set 21 is mounted on a bottom portion of the casing 11. The LED luminous element 22 is mounted opposite to the laser luminous element 23 on the lens set 21 and has an included angle with a horizontal plane. The optical structure 2 of the optical mouse 1 adds the laser luminous element 23 as the light source to enhance the sensitivity of the optical mouse 1 related to the surface of an object. Hence, if the optical mouse 1 moves over a smooth surface, it still can transmit data regarding the displacement precisely to the computer. The image-detecting element 24 is disposed on a top portion of the lens set 21 for receiving an image produced by the LED luminous element 22 and the laser luminous element 23 projecting a light beam to any kind of surface. The digital signal processing element 25 is electrically connected inside the image-detecting element 24 for receiving an image data token by the image-detecting element 24 and computing the moving direction and distance of the optical mouse 1 precisely. Therefore, the optical structure 2 can exactly and sensitively detect the image produced by the optical mouse 1 sliding over any kind of surface.

The circuit board 12 is disposed inside the casing 11 and is electrically connected to the LED luminous element 22, the laser luminous element 23 and the image-detecting element 24 respectively for driving the optical structure 2. Hence, the optical mouse 1 is suitable for operating upon any kind of surface.

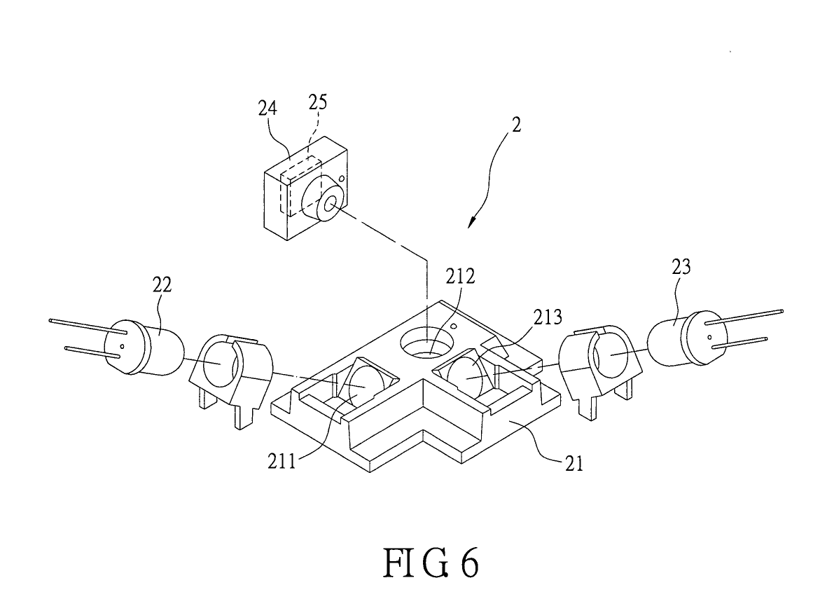

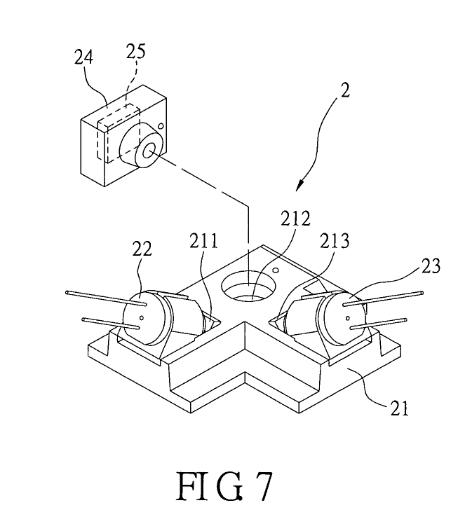

Referring to FIGS. 6 and 7, which are respectively decomposition and composition views of a second preferred embodiment of the optical structure of the optical mouse of the present invention.

The lens set 21 is mounted on the bottom portion of the casing 11. The LED luminous element 22 is mounted on a side of the lens set 21 and has an included angle with a horizontal plane.

The laser luminous element 23 is mounted on another side of the lens set 21 and is perpendicular and adjacent to the LED luminous element 22 and has an included angle with the horizontal plane. Therefore, the second preferred embodiment of the optical structure 2 can exactly and sensitively detect the image produced by the optical mouse sliding over any kind of surface.

So, the present invention has the following characteristics:

The present invention provides an optical mouse 1 and an optical structure 2 for the optical mouse 1 having a laser luminous element 23 for enhancing the sensitivity of the optical mouse 1 related to the surface of an object. Hence, if the optical mouse 1 moves over a smooth surface, it still can transmit data regarding the displacement precisely to the computer. The present invention adds a laser luminous element 23 as a light source, so that the optical mouse 1 can receive the data from the surface of the object precisely.

There has thus been described a new, novel and heretofore unobvious optical mouse and an optical structure of the optical mouse eliminating the aforesaid problems in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An optical structure of an optical mouse mounted inside a casing of the optical mouse, comprising:
a lens set mounted on a bottom portion of the casing;
an LED luminous element mounted on a side of the lens set and having an included angle with a horizontal plane;
a laser luminous element mounted on an other side of the lens set and opposite to the LED luminous element and having an included angle with the horizontal plane; and
an image-detecting element disposed on a top portion of the lens set for receiving an image produced by the LED luminous element and the laser luminous element projecting a light beam to any kind of surface; whereby the optical structure exactly and sensitively detects the image produced by the optical mouse sliding over any kind of surface.

2. The optical structure of the optical mouse of claim 1, wherein the lens set has a first lens, a second lens and a third lens, wherein the first lens is opposite to the LED luminous element, the second lens is opposite to the image-detecting element and the third lens is opposite to the laser luminous element.

3. The optical structure of the optical mouse of claim 1, further comprising a digital signal processing element electrically connected inside the image-detecting element for receiving an image data token by the image-detecting element and computing the moving direction and distance of the optical mouse precisely.

4. An optical mouse, comprising:
a casing;
an optical structure mounted inside the casing, including a lens set mounted on a bottom portion of the casing; an LED luminous element mounted on a side of the lens set and having an included angle with a horizontal plane; a laser luminous element mounted on an other side of the lens set and opposite to the LED luminous element and having an included angle with the horizontal plane; and an image-detecting element disposed on a top portion of the lens set for receiving an image produced by the LED luminous element and the laser luminous element projecting a light beam to any kind of surface; and
a circuit board disposed inside the casing and electrically connected to the LED luminous element, the laser luminous element, and the image-detecting element respectively for driving the optical structure; whereby the optical mouse is suitable for operating on any kind of surface.

5. The optical mouse of claim 4, wherein the lens set has a first lens, a second lens and a third lens, wherein the first lens is opposite to the LED luminous element, the second lens is opposite to the image-detecting element and the third lens is opposite to the laser luminous element.

6. The optical mouse of claim 4, further comprising a digital signal processing element electrically connected inside the image-detecting element for receiving an image data token by the image-detecting element and computing the moving direction and distance of the optical mouse precisely.

7. An optical structure of an optical mouse mounted inside a casing of the optical mouse, comprising:
a lens set mounted on a bottom portion of the casing;
an LED luminous element mounted on a side of the lens set and having an included angle with a horizontal plane;
a laser luminous element mounted on an other side of the lens set and perpendicular and adjacent to the LED luminous element and having an included angle with the horizontal plane; and
an image-detecting element disposed on a top portion of the lens set for receiving an image produced by the LED luminous element and the laser luminous element projecting a light beam to any kind of surface; whereby the optical structure exactly and sensitively detects the image produced by the optical mouse sliding over any kind of surface.

8. The optical structure of the optical mouse of claim 7, wherein the lens set has a first lens, a second lens and a third lens, wherein the first lens is opposite to the LED luminous element, the second lens is opposite to the image-detecting element and the third lens is opposite to the laser luminous element.

9. The optical structure of the optical mouse of claim 7, further comprising a digital signal processing element electrically connected inside the image-detecting element for receiving an image data received by the image-detecting element and computing the moving direction and distance of the optical mouse precisely.

10. An optical mouse, comprising:
a casing;
an optical structure mounted inside the casing, including a lens set mounted on a bottom portion of the casing; an LED luminous element mounted on a side of the lens set and having an included angle with a horizontal plane; a laser luminous element mounted on an other side of the lens set and perpendicular and adjacent to the LED luminous element and having an included angle with the horizontal plane; and an image-detecting element disposed on a top portion of the lens set for receiving an image produced by the LED luminous element and the laser luminous element projecting a light beam to any kind of surface; and
a circuit board disposed inside the casing and electrically connected to the LED luminous element, the laser luminous element, and the image-detecting element respectively for driving the optical structure; whereby the optical mouse is suitable for operating on any kind of surface.

11. The optical mouse of claim 10, wherein the lens set having a first lens, a second lens and a third lens, wherein the first lens is opposite to the LED luminous element, the second lens is opposite to the image-detecting element and the third lens is opposite to the laser luminous element.

12. The optical mouse of claim 10, further comprising a digital signal processing element electrically connected inside the image-detecting element for receiving an image data received by the image-detecting element and computing the moving direction and distant of the optical mouse precisely.
